(19) United States
(12) Patent Application Publication
(10) Pub. No.: US 2019/0142017 A1
(43) Pub. Date: May 16, 2019

(54) COOKING SYSTEM FOR A COOKING MACHINE, AND ASSOCIATED MACHINE FOR PREPARING PANCAKES AND METHOD

(71) Applicant: HOLDING BERNARD BLACHERE, Chateaurenard (FR)

(72) Inventors: Bernard BLACHERE, Saint Remy de Provence (FR); Pierre VIDAL, Noves (FR)

(21) Appl. No.: 15/921,392

(22) Filed: Mar. 14, 2018

(30) Foreign Application Priority Data
Nov. 14, 2017 (FR) 17 60701

(51) Int. Cl. A21B 5/03; A23L 5/10

(52) U.S. Cl. CPC A21B 5/03; A23V 2002/00; A23L 5/10

(57) ABSTRACT

The cooking system for a cooking machine, in particular, a machine for preparing pancakes includes a plurality of cooking devices configured to be successively and cyclically moved to the end of a device for dispensing product to be cooked, in particular of a dough-injection system. There is a driving system for the cooking devices, and a control unit connected to the driving system and to the dispensing device. The control unit is configured to select part of the cooking devices, on which the product to be cooked is dispensed. The invention also relates to an associated automaton, a machine and a cooking method.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a cooking system for a cooking machine such as a machine for preparing pancakes. The invention relates in addition to an associated machine for preparing pancakes and an associated method.

### 2. Description of Related Art Including Information Disclosed Under 37 CFR 1.97 and 37 CFR 1.98

In the field of the machines for preparing pancakes, machines for preparing have been proposed comprising cooking plates arranged as a carousel, and pivoting around a pancake-dough dispensing area. In use, the cooking plates are switched on and pivoted to the dispensing area for cooking in line in order to provide cooked pancakes.

Unfortunately, the prior art machines for preparing pancakes are not satisfactory enough, since, when the demand for cooked pancakes drops or is zero, they do not permit to adequately adapt to cooking less pancakes. This also applies when said demand increases.

A first aim of the present invention is to provide an improved system permitting to adapt the production of cooked pancakes to a demand that decreases, is zero or increases.

### BRIEF SUMMARY OF THE INVENTION

To this end, the invention relates to a cooking system for a cooking machine, in particular for a machine for preparing pancakes, the system comprising

a plurality of cooking devices configured to be successively and cyclically moved to the end of a device for dispensing product to be cooked, in particular of a dough-injection system,

a system for driving the cooking devices,

a control unit connected to the driving system and to the dispensing device.

According to a first aspect, the control unit is configured to select part of the cooking devices, onto which the product to be cooked is dispensed.

Advantageously, the control unit permits a user to reduce the cooking rate of the machine in the event of a drop in demand and to re-increase said rate when necessary, without any need to turn off the machine. A cooking machine integrating such a system thus comprises a particular means for managing the rates.

According to other aspects taken individually or combined in all technically feasible combinations:

the control unit is configured to select said part of the cooking devices at a regular or almost regular time interval; and/or

the system comprises a mark identifying the cooking devices and a corresponding mark on an adjusting means of the control unit; and/or

said part of the selectable cooking devices corresponds, on the one hand, to one cooking device, on the other hand, to more than one cooking device, in particular about half of the total cooking devices; and/or

the cooking devices comprise six cooking plates; and/or

the control unit is configured to select one adjustment position out of three, corresponding to one plate, three plates, and six plates; and/or

the system comprises a circular support made integral with the cooking devices and preferably a circular handle extending around the circular support; and/o

the dispensing device is movable between an activation position, in which it is at the level of a dispensing point, and an inactivation position, in which it is at a distance from the dispensing point, and said positions activate or inactivate the driving system and preferably an automatic product dispensing control.

Another object of the invention relates to an automaton for preparing pancakes of a control unit, in particular of a system according to the invention, configured to automatically control a driving system for cooking devices and a dispensing of said product onto the cooking devices, wherein it is adjustable to select part of the cooking devices, onto which a cooking product is dispensed.

The invention relates in addition to a machine for preparing pancakes, wherein it comprises a system according to the invention.

According to a variant, the machine comprises an injection and spreading system for cooking dough comprising

a dough container having an outlet,

an injection pump connected to the outlet of the container,

a spreader connected to the injection pump and configured to spread a dough on a cooking surface, and

an injection circuit connecting the container to the spreader.

Another object of the invention relates a method for preparing pancakes, in particular by means of a system according to the invention or a machine according to the invention, the method comprising the steps of:

varying the number of cooking devices, onto which a pancake dough is dispensed, and

cooking the pancake dough.

### BRIEF DESCRIPTION OF THE SEVERAL VIEWS OF THE DRAWINGS

The invention will be described in further detail by the description of non-restrictive embodiments, and based on the attached figures, in which:

FIG. 1 is a view in space of the machine for preparing pancakes according to a preferred variant of the invention;

FIG. 2A is a view in space of a cooking device of the machine of FIG. 1;

FIG. 2B is a view in space of a front face of a control panel of the machine of FIG. 1;

FIG. 2C is a view in space of a front upper face of the control panel of FIG. 2B;

FIG. 3 is a top view of the machine of FIG. 1;

FIG. 4 is a diagram of a method for preparing pancakes using the machine of FIG. 1;

FIG. 5A is a view in space similar to that of FIG. 1, illustrating an injection and spreading system for pancake dough;

FIG. 5B is a close-up view of the injection and spreading system of FIG. 5A;

FIG. 6A is a view in space of an assembled injection pump of the system of FIGS. 5A and 5B;

FIG. 6B is an exploded view of the injection pump of FIG. 6A;

FIG. 7A is a view in space of a spreader of the system of FIGS. 5A and 5B;

FIG. 7B is a view in space of a partially disassembled connection mechanism of the spreader of FIG. 7A;

FIG. 7C is an exploded view in space of the spreader and connection mechanism of FIGS. 7A and 7B;

FIG. 7D is an exploded view of a spreader according to a second variant;

FIG. 7E is a view in space of a plate of the spreader of FIG. 7D; and

FIG. 8 is a diagram of an injection circuit of the system of FIGS. 5A and 5B.

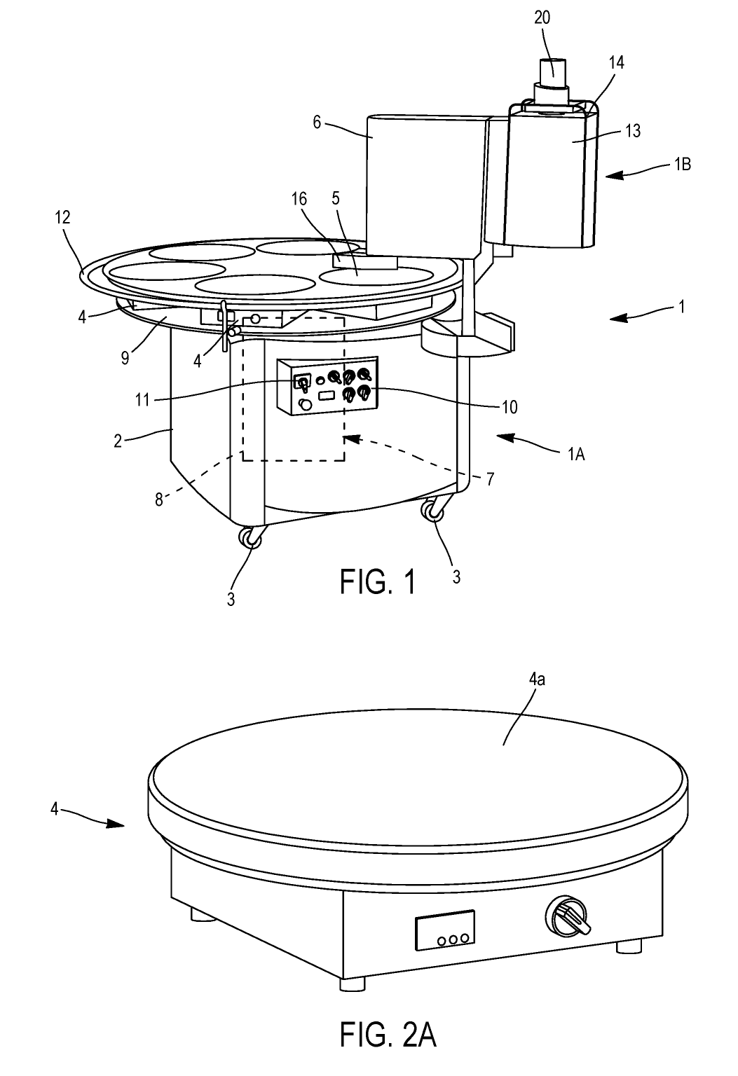

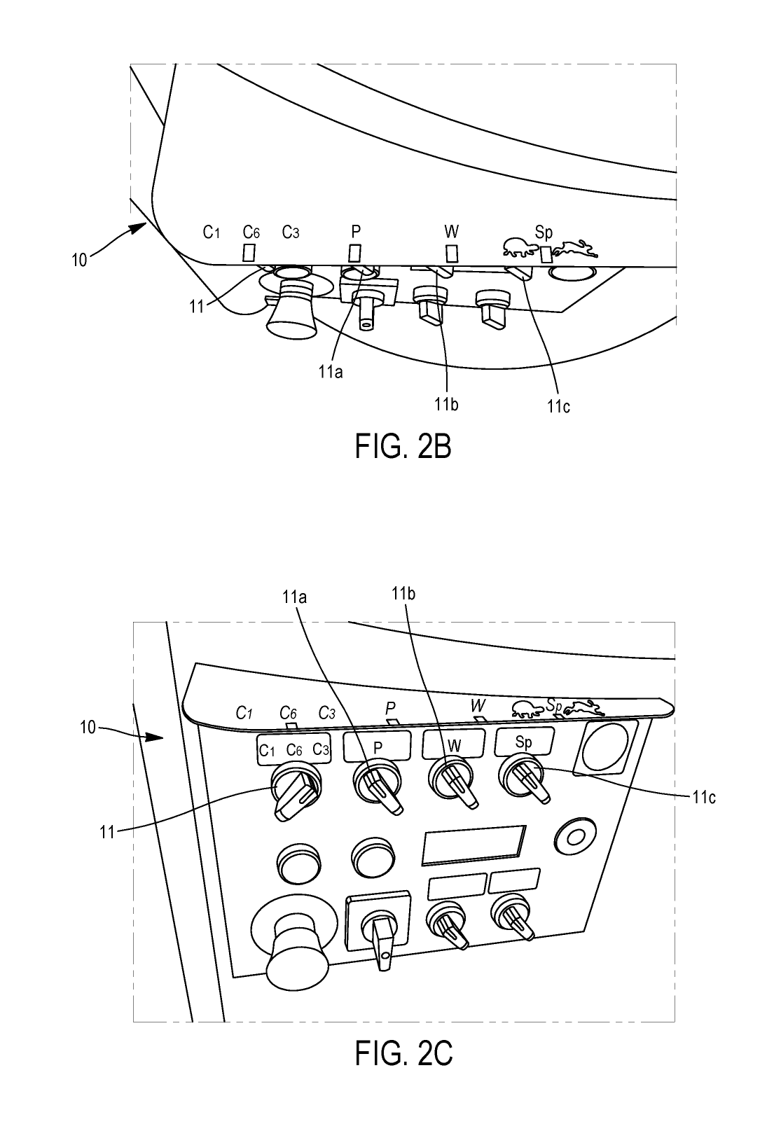

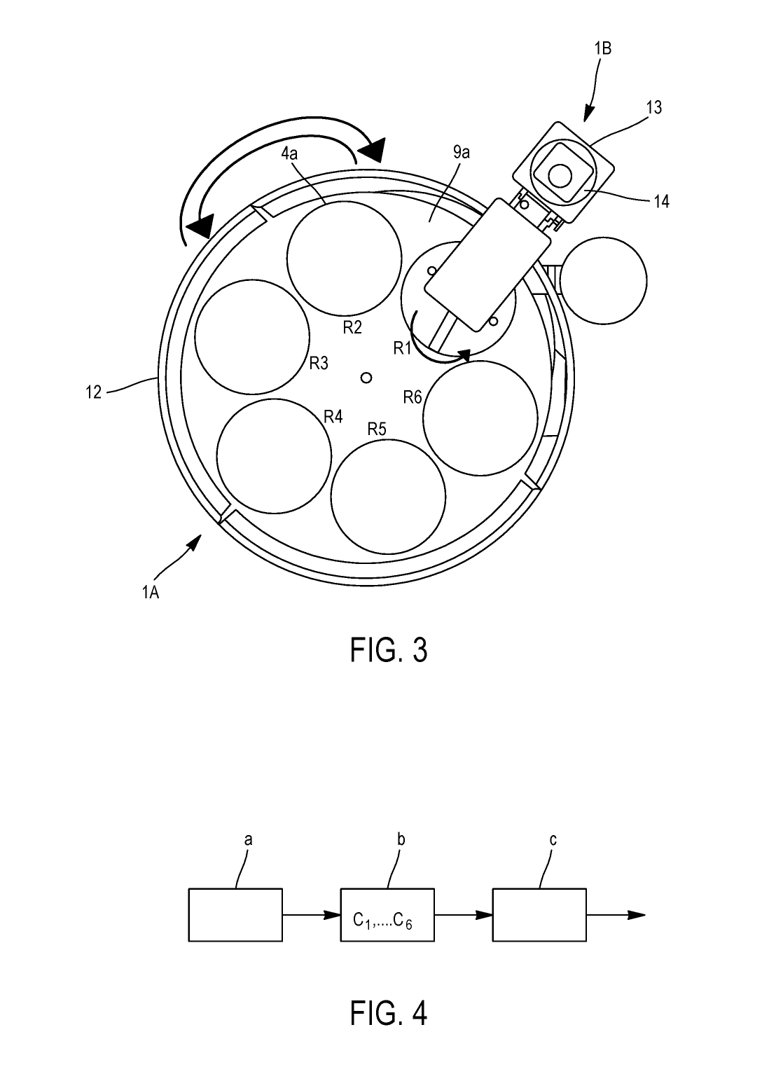

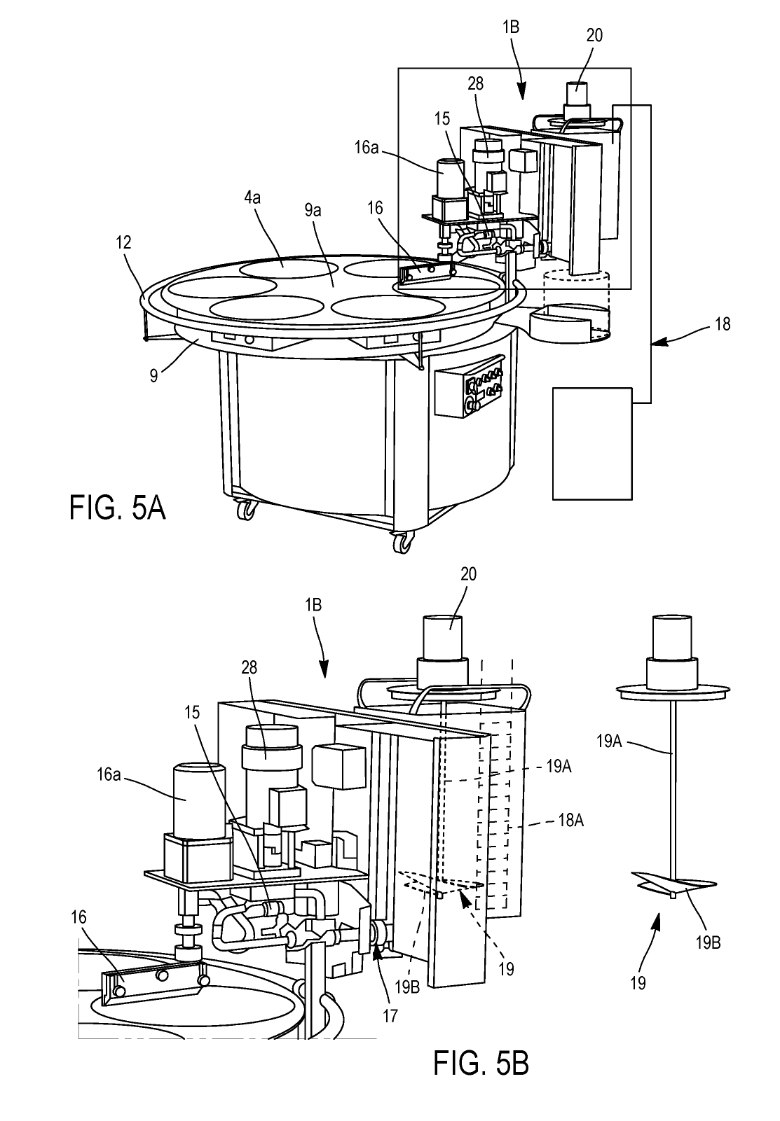

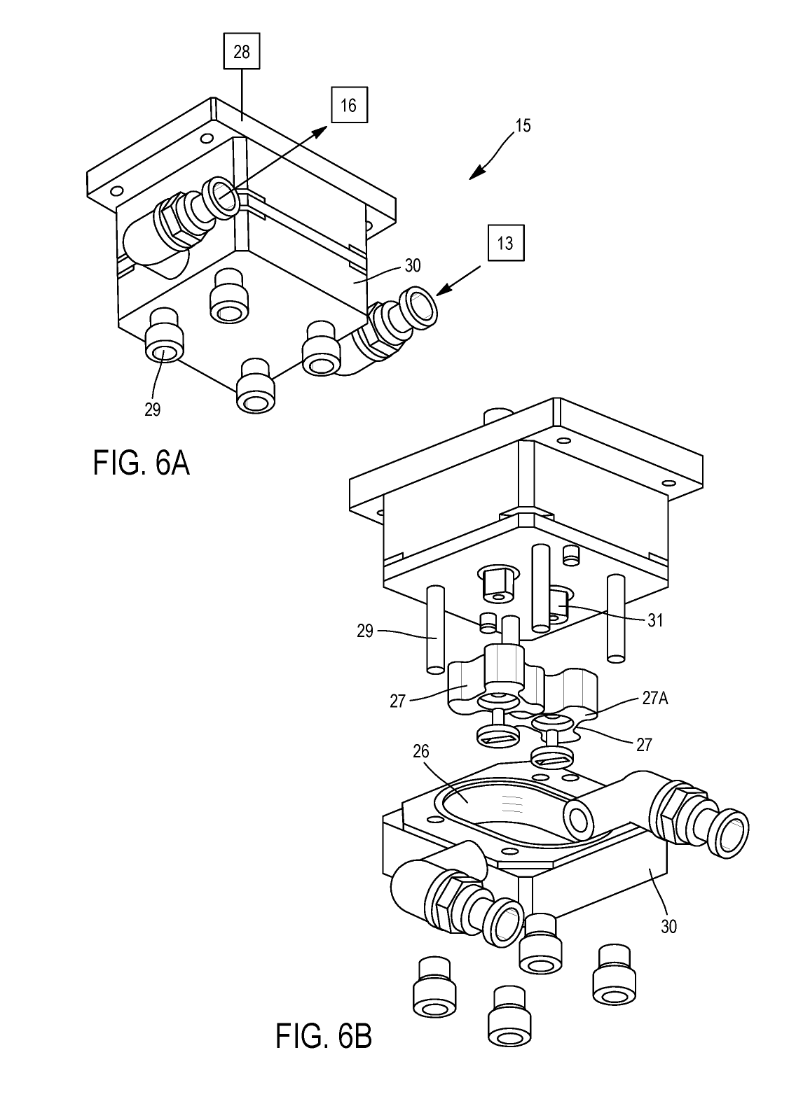

### DETAILED DESCRIPTION OF THE INVENTION

The invention generally relates to a machine for preparing pancakes 1 and to particular systems 1A, 1B permitting a significantly improved operation in comparison with the prior art.

To do this, the machine preferably comprises a cooking system 1A, and preferably a system for injecting and spreading cooking dough 1B. The systems 1A and 1B of the machine 1 are part of the invention.

The machine 1 may comprise a body 2 comprising components, and preferably mounted on rolling means 3, in particular four wheels. The body 2 may have a height of less than 1 meter, and the machine preferably has a height of about 1.5 m and a width of about 1.5 m

Cooking and Management of Production Rates

A first part of the invention relates to a cooking system 1A in particular for a machine for preparing pancakes 1.

The cooking system 1A according to the invention comprises a plurality of cooking devices 4, in particular a plurality of cooking plates, preferably arranged as a carousel. The cooking devices can be masked laterally by a circular blade (not shown). Preferably, the system comprises more than two cooking plates, more preferably six cooking plates. Six active cooking plates correspond to a good compromise between a delivery of pancakes in periods of affluence of passers-by, while having a user handling the machine without too much difficulty.

The cooking devices 4 are configured to be moved successively and cyclically. Thus, a dough dispensing point 5 can be provided, whereby all the cooking devices 4 return to the dispensing point 5. At the dispensing point 5 is provided a device for dispensing product to be cooked 6, in particular pancake dough. More particularly, the dispensing device 6 is part of a dough injection system 1 B, which will be described in detail in a separate portion.

The cooking system 1A comprises in addition a system for driving 7 the cooking devices 4, in particular for driving in rotation. The axis of rotation here is vertical. In a preferred variant, a plate-driving motor 8 is preferably provided under the cooking devices 4, in particular hidden in the body 2. The rotor of the motor 8 is connected to a support 9 of the cooking devices 4. A preferred electric connection means for the cooking devices 4 compatible with their rotation, such as a rotating collector system, is known to those skilled in the art and will not be discussed more in detail.

The cooking system 1A comprises in addition a control unit 10 connected to the driving system 7 and to the dispensing device 6, in particular to the dough injection system 1 B. The control unit 10 is configured to automate the rotation of the cooking devices 4 and the dispensing of product, in particular of pancake dough. More particularly, when a cooking device 4, on which the product must be cooked, is arranged under the dispensing device 6, the control unit 10 controls the dispensing of the product to said cooking device 4. In addition, in particular when a next cooking device 4, on which the product must be cooked, is not arranged under the dispensing device 6, the control unit 10 controls the rotation of the driving system so as to position said cooking device 4 under the dispensing device 6.

According to a first aspect of the invention, the control unit 10 is configured to select part of the cooking devices 4, onto which the product to be cooked, in particular the pancake dough, is dispensed.

Advantageously, by selecting part of the cooking devices 4, the control unit 10 permits a user to reduce the cooking rate of the machine 1 in the event of a drop in demand and to increase said rate when necessary, by reselecting more, even all the cooking devices 4, without any need to turn off and then turn on the machine 1.

Surprisingly, the applicant has found that in constant use without turning off the machine 1, but by reducing and increasing the rate, a smell of cooked pancake spreads throughout the use around the machine 1 and stimulates the appetite of the passers-by, which increases the demand for pancakes.

In particular, said part of selectable cooking devices corresponds, on the one hand, to one cooking device 4, on the other hand, to more than one cooking device 4, for example about half of the total of the cooking devices 4. In other words, the control unit 10 preferably permits to select several controls for the number of cooking devices 4 being used. For example, the control unit 10 is configured to select one setting position out of several, in particular out of three, corresponding here to either one plate, three plates, or six cooking plates.

According to a variant, the control unit 10 is configured to select said part of the cooking devices 4 over a regular or almost regular time interval. By “selection over a regular interval” is understood a selection of a fraction of the cooking devices 4, alternating regularly the number of selected devices and the number of non-selected devices subsequently. In a less preferred variant, it is possible to consider a non-regular interval when it is not possible to have a strict alternation of selected and non-selected cooking devices 4, for example when the total number of cooking devices 4 is odd.

In particular, a control C3 is actuated to select half of the cooking devices 4, here namely three cooking plates. The control unit 10 then considers that it is necessary to alternate a cooking plate, on which the pancake dough must be poured, then a cooking plate, on which the pancake dough must not be poured, and so on. It may be considered to modify the invention for an odd number of cooking plates and to adapt the control unit 10 to an almost regular time interval.

Preferably, another control C1 is actuated to select a single cooking device 4 among all the cooking devices 4. Finally, another control C6 permits to select all the cooking devices 4.

In a particularly surprising way, the applicant has found that by alternating the selected cooking devices 4 and the non-selected cooking devices 4, a significant gain in space is obtained, because these controls C3 and C1 permit to have free cooking plates permitting to turn the pancake upside down and to garnish it while cooking the underside, where a simple slowdown would require the use of consecutive plates.

According to a variant, the cooking system 1A is configured so that the same positions of cooking devices 4 are associated with the corresponding controls for selecting a part of the cooking devices 4. In other words, a control of three active cooking plates corresponds to three final positions of cooking plates among the six plates. This configuration permits to simplify the architecture of the automaton of the control unit 10.

In particular, the cooking system 1A comprises a mark identifying the cooking devices 4 and a corresponding mark on an adjusting means 11 of the control unit 10, which is for example a control pivoting to several positions, for example three positions. One can consider a set of knobs without departing from the scope of the invention. The adjustment means 11 permits to actuate a control activating all the cooking devices 4, a control activating a part, for example half, and preferably a control activating a single cooking device 4. For example, a mark “R1 to R6” identifies all the cooking devices 4, and the control “C6” causes the dispensing of product onto all the cooking devices 4. The control “C3” causes the dispensing of product onto the devices 4 with the marks R1, R3 and R6. The control “C1” causes the dispensing of product onto the cooking device 4 with the mark R1. The non-activated/non-selected cooking devices 4 do not receive any dispensing of product, but are preferably switched on during the whole use.

The mark on the positions of the cooking devices 4 permits to identify the positions at which the machine will pour the dough, which facilitates the use, because the user can anticipate the next dispensing of product.

According to a variant, the machine, in particular the cooking system, more particularly the control unit, comprises a control panel, on which controls are provided. The control panel is preferably provided on the body 2 of the machine. The controls are preferably rotary knobs. For example, said adjustment control 11 is provided on the panel. In addition, a purge control 11a (P: “dough purge”) is provided in order to actuate a purging of the dough in the dispensing device. In addition, a wash control 11b (W.: “wash water” is provided to actuate a wash and/or rinse operation.) In addition, a wash control 11c (Sp.: “speed” is provided to actuate two rotation speeds of the circular support. A particular operation of the controls 11a and 11b is described in detail below.

Preferably, the control panel is substantially vertical on a side of the machine. This permits a space saving. The panel includes an upper face, on which actuating positions of the controls are identified. Advantageously, this arrangement permits to control without having to bend down to the level of the control panel. In particular, icons are provided to quickly identify the positions of some controls, for example a hare for the fast position, and a turtle for the slow position.

Preferably, the cooking system 1A comprises a circular support 9, to which the cooking devices 4 can be removably fastened. More preferably, the cooking system 1A comprises a handle 12, here a circular handle, extending around the circular support 9 while being made integral therewith. A plate cover 9a may be provided to cover the cooking devices 4, while leaving cooking surfaces 4a uncovered. This plate forms a stainless steel working plate preventing soil in terms of sweet or salty pancake ingredients from falling between the cooking devices. This stainless steel finish thus avoids an important soiling, simplifies and greatly facilitates cleaning, ensures good hygiene and contributes to the aesthetics of the machine.

Preferably, the dispensing device 6 is movable between an activation position, in which it is at the level of the dispensing point 5, and an inactivation position, in which it is at a distance from the dispensing point 5. More preferably, the dispensing device 6 is rotated, in particular horizontally, between the activation position and the inactivation position. According to a variant, an automatic activation control is provided when the dispensing device is in the activation position, and the deactivation takes place in the inactivation position. A system based on an electrical connection/disconnection according to said positions can be considered.

Advantageously, this arrangement permits to free up space at the level of the dispensing point in the inactivation position, while stopping the rotation and/or the dispensing of product.

According to a variant, the control unit 10 connected to the dispensing device 6 is in addition connected to a particular washing circuit in an arrangement described in more detail below. The control unit 10 is preferably configured to automatically trigger a washing of the dispensing device 6 when the latter is in the inactivation position, for example after a determined period that can be adjustable. Preferably, a signaling of the beginning of the washing cycle is provided for example by means of three preliminary sound beeps.

According to a more preferred variant, when the dispensing device is in an intermediate position between the activation position and the inactivation position, the system, in particular the control unit, is configured to emit an alarm, for example after a determined period of time that can be adjustable, until the dispensing device is moved into either the activation position or the inactivation position. The period is for example 1 minute. The alarm is preferably one or several sound beeps, but one can also consider another type of sound alarm and/or visual and/or sensory alarm. This arrangement permits to limit the congestions of the dispensing device.

Another object of the invention relates to a particular method for preparing pancakes. The method is preferably carried out by means of a system or a machine 1 as described in the present application.

The method comprises, in particular after having switched on the machine 1 and the cooking devices 4 in a step (a), at least one step (b) consisting in varying the number of cooking devices 4 onto which the pancake dough is dispensed, and a step (c) consisting in cooking the pancake dough.

Preferably, all the cooking plates are switched on during the use of the machine 1, irrespective of the rate being selected, in particular during a whole day. The plates switched on in low rate permit to heat the pancakes turned upside down to be garnished.

The cooking temperature is preferably higher than 200 degrees Celsius (° C.), more preferably about 250° C. These temperatures permit a quick cooking of the pancake dough and a pleasant cooking crackling.

The invention relates in addition to an automaton for preparing pancakes particularly adapted to the invention. In particular, the automaton is part of the control unit as described above.

The automaton is configured to automatically control a driving system 7 for cooking devices 4 and a dispensing of said product onto the cooking devices 4, in particular depending on the number of cooking devices 4, onto which the product is to be dispensed.

According to an interesting aspect, the automaton is adjustable to select part of the cooking devices, onto which a product to be cooked is dispensed.

Injection and Spreading

A second part of the invention relates to a system for injecting and spreading cooking dough 1B, in particular for a machine for preparing pancakes 1.

An injection system permits to avoid arranging the dough container above the cooking surface, which results into space saving.

The system 1B comprises a dough container 13 having preferably a lower outlet. The container 13 is a vessel that can be filled with dough. For example, an upper lid 14 may be raised in order to pour dough into the container 13. The lid is preferably a tray configured to be placed on the container 13 for quick filling operations.

The system 1B comprises in addition an injection pump 15 connected to the lower outlet of the container 13. The actuation of the pump 15 permits to take dough from the container 13 in order to dispense it onto a cooking means 4. A preferred injection pump will be described more in detail below.

In particular, the system 1B comprises a container compartment and an injection compartment preferably juxtaposed and parallel to the container compartment.

The injection and spreading system 1B comprises in addition a spreader 16 connected to the injection pump 15 and configured to spread a dough on a cooking surface 4a. In particular, the system 1B is configured to dispense dough onto the cooking surface 4a and to spread said dough on the cooking surface 4a, in particular in order to form a pancake.

To this end, the system comprises in addition an injection circuit 17 connecting the container 13 to the spreader 16. The injection circuit 17 permits to convey the dough from the container 13 to the cooking means 4.

Advantageously, the spreader 16 permits to automate the spreading of the dough on the cooking surface 4a in order to prevent a user from carrying out this spreading with fatigue hazards that can lead to varying thicknesses of dough and fluctuating pancake-cooking operations. The spreader 16 thus permits to have a uniform spreading over all the cooking operations, and thus to have a constant quality of the cooked pancakes.

According to a variant, the injection and spreading system 1B comprises a refrigeration system 18 for the container 13. In particular, a refrigeration structure 18A such as a coil is arranged in the pancake-dough container 13. The refrigeration structure 18A is for example arranged in a double wall of the container 13. A refrigeration device 18B connected to the refrigeration structure 18A can be accommodated in or near the body 2. For example, the temperature of the container is set to above 0° C., preferably between 4 and 6° C., more preferably to about 5° C. A temperature of 5° C. corresponds to meeting the French regulation for the preservation of the pancake dough, here during the complete duration of use.

Preferably, the system 1B comprises in addition at least one means for preventing congestions of the injection circuit. The means for preventing congestion permit to facilitate the use of the machine by limiting the clogging of the injection circuit by the dough, for example when it stagnates and blocks the ducts or blocks determined parts of the circuit.

In addition, the injection circuit 17 associated with means for preventing congestion permits to have an efficient apparatus that can be used for an extended period without having an alteration in the use of the machine for preparing pancakes 1, because the use can be extended without interruption.

In addition, the injection circuit 17 associated with the pump 15 permits to have a uniform dispensing of pancake dough.

Surprisingly, the applicant has found that the simple refrigeration of the pancake dough throughout the use of the machine permitted to limit the obstruction of an improved injection circuit 17 comprising in particular driving parts inside the circuit. It seems that at room temperature the components of the dough interact so as to create a cluster, probably of starch absorbing milk and eggs, which blocks determined parts or clogs the injection circuit. The invention permits to cope therewith.

According to a variant, one of the means for preventing congestions of the injection circuit comprises a means 19 for mixing the contents of the container 13. In particular, a longitudinal structure 19A ending with a mixing element 19B, such as a beater, a propeller or preferably a mixing saucer, is provided dipping into the container 13. Advantageously, the elements of the pancake dough likely to sediment, such as butter and the other fats or clusters, are continuously mixed into the pancake dough, so as to avoid an obstruction of the injection circuit 17. More preferably, a mixing saucer is arranged substantially at the level of the outlet of the container in order to further limit the obstructions of the dough. The saucer has at least one radial groove.

The system preferably comprises the container lid 14, onto which is mounted, on the one hand, a driving means for the mixing means, in particular a mixing motor 20, towards the outside of the container 13, and, on the other hand, the mixing means 19, towards the inside of the container 13. More particularly, the mixing element 19B fastened to the lid 14 can be at least partially withdrawn from the container 13 by removing the lid 14 for quick filling operations without the mixing element 19B occupying space in the container 13.

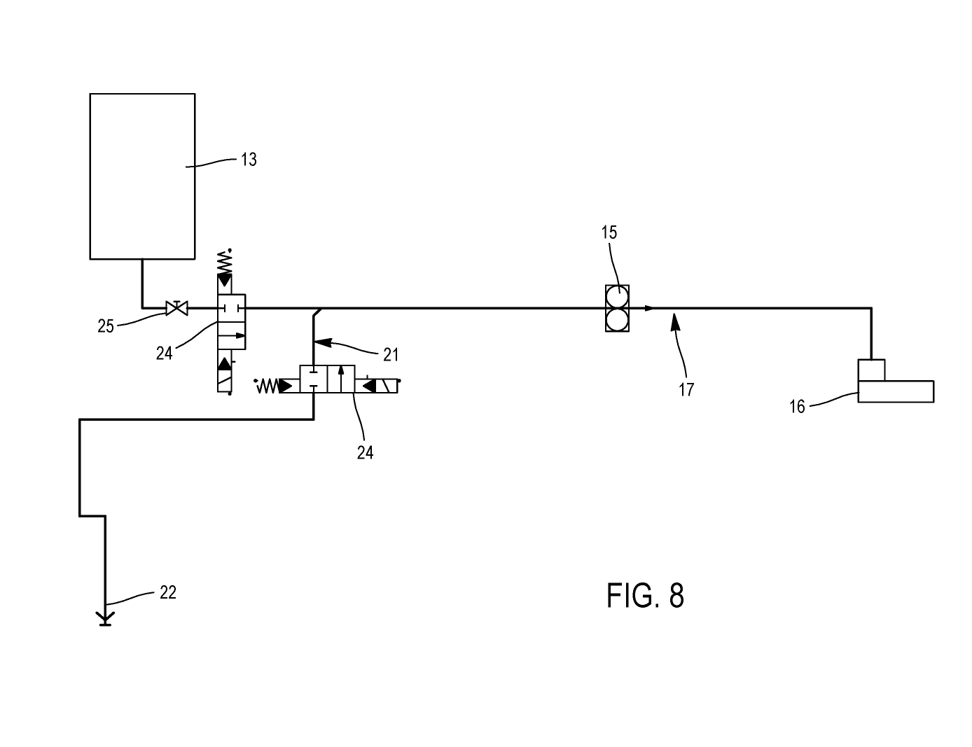

According to a variant, one of the means for preventing congestion of the injection circuit 17 comprises a washing circuit 21 for the injection circuit 17, mounted in particular parallel to a portion of the injection circuit 17. More particularly, the washing circuit 21 preferably ends at a point on the injection circuit 17 so as to permit the injection circuit 17 to be washed between the most upstream point and the downstream end of the injection circuit, namely towards the spreader 16. The washing circuit 21 permits to perform a washing and preferably a purging of the injection circuit 17. Thus, the dough residues liable to obstruct the conduits are evacuated from the injection circuit 17. The washing circuit 21 preferably comprises a water inlet 22. It is in addition possible to provide a washing pump, a water container and/or a source of cleaning product, but these variants are less preferred. Solenoid valves 24 can be provided and connected to an automaton in order to optimize the washing and/or purging of the injection circuit 17. Valves 25 may be provided in order to prevent the reflux. A particularly preferred mounting is illustrated in FIG. 8.

The valve 25 and the solenoid valves 24 can be used for the application of the purge control 11a (P. P: “dough purging”) and wash control 11b (W.W.: “wash water”). For example, for purging the dough, the solenoid valve 24 in front of the valve 25 is closed and the pump 15 is actuated in order to evacuate the residual dough in the injection circuit 17. For the washing, the solenoid valve 24 of the washing circuit is in addition opened in order to start a washing of the injection circuit 17.

Between two uses of the system, for example at the end of the day, a cleaning product can be poured into the container 13 and moves through the injection circuit. After a while, the system can be rinsed by a “dough purging” cycle and then a wash cycle.

According to a variant, one of the means for preventing congestions of the injection circuit comprises a particular premix of pancake dough. The components of the pancake dough can be optimized so as to avoid clogging of the injection circuit while having constantly a good pancake quality.

The dehydrated pancake dough premixes to be mixed with water may have good fluidity, but the taste is generally unsatisfactory. The pancake doughs entirely prepared before use or stored unfortunately do not have a satisfactory lifetime. In a particularly surprising way, the applicant has found that a premix comprising dehydrated pancake-dough ingredients, except milk, associated with milk permitted to reconstitute a pancake dough with a good fluidity and an improved taste, in comparison with the classic premixes, while having a good lifetime. It seems that the dehydration of some milk components and their rehydration are greatly prejudicial to the quality of the reconstituted dough. The invention permits to cope with these drawbacks.

More particularly, the pancake dough premix does not comprise butter. Advantageously, this composition significantly limits the number of blockages of the injection circuit, even in the event of stagnation. In addition, the pancake dough is more digestible and does not cause red stains on the pancakes.

An example of a premix composition comprises a dry solid portion and a liquid portion. The solid portion may comprise flour, whole eggs in powder and preferably salt. The liquid portion comprises milk or reconstituted milk. Reconstituted milk permits to control the ingredients while milk can have varying compositions, even from the same supplier.

According to a variant, the pump 15 has a particular configuration. It is formed by a recess 26 connected to the injection circuit 17. The recess 26 of the pump 15 receives the dough from the injection circuit 17. In addition, the recess 26 of the pump 15 comprises at least one pumping structure 27 driven in motion in the recess 26. Preferably, the pumping structures are two lobe wheels configured to be driven in rotation in the recess 26 of the pump 15. The axis of rotation is preferably vertical. The movements of said pumping structure 27 in the recess 26 permit to refine the amount of dough. In particular, the amount of dough moved by the pumping structures 27, for example between the lobes 27A, is optimized so as to correspond to an amount corresponding to a number of revolutions of the pumping structures 27. More particularly, said pumping structure 27 is driven in rotation for example by means of a pump motor 28. The speed of rotation can be used to refine the amount of injected dough.

The recess 26 of the pump 15 is preferably a prismatic recess with a flat base, more preferably a horizontal base. In particular, the base is substantially oval, ellipsoid or preferably oblong. The lobe wheels are preferably driven in front of the circular portions of the recess 26.

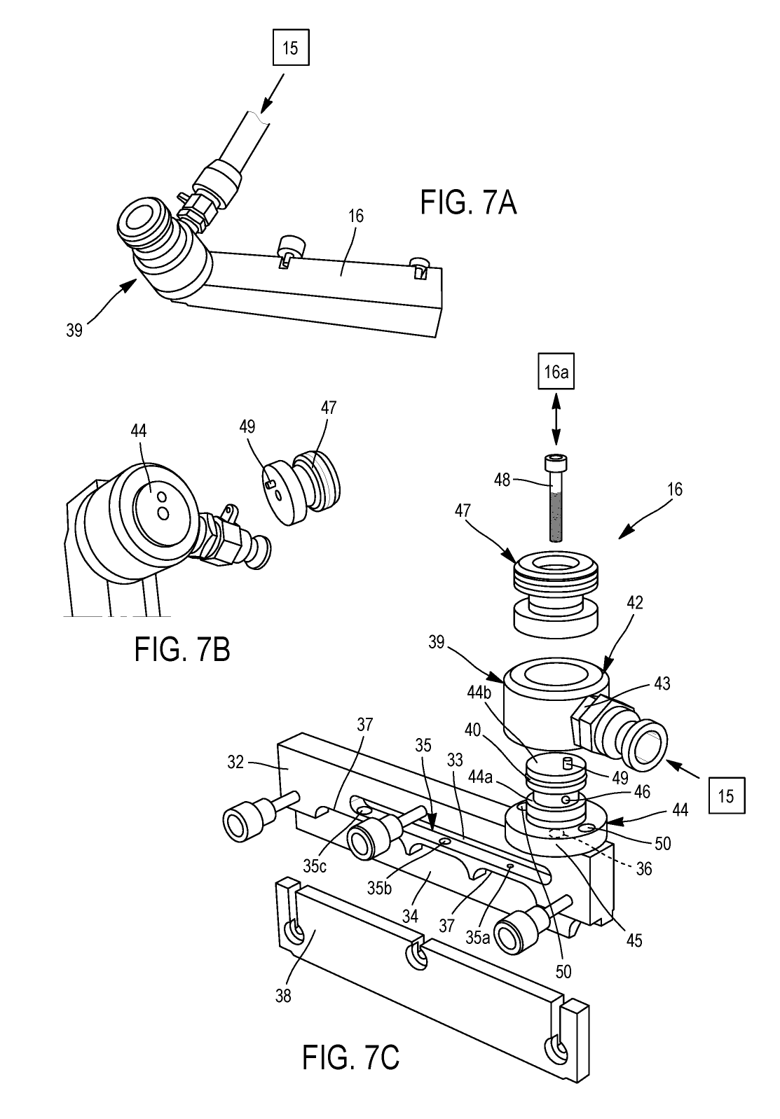

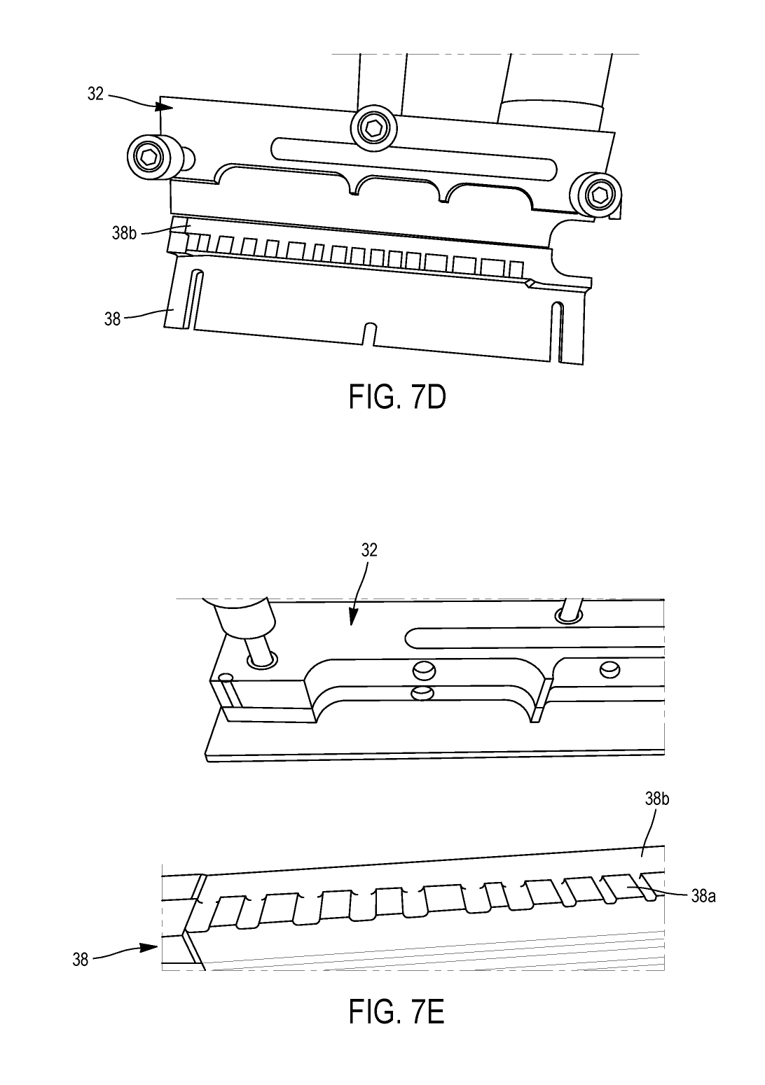

As illustrated in FIGS. 6A and 6B, the pump 15 has preferably a cubic or parallelepipedal overall structure so as to optimize the spaces of arrangement of the injection system 1B. In particular, the pump 15 is formed by a plate assembly with through fastening means 29 such as a bolting system, for example with four fastening structures. At least one pump plate 30 comprises the recess 26 comprising said pumping structure 27. At least one driving element 31, here an upper element, is is made integral with said pumping structure 27 in order to form a connection to a driving means such as said pump motor 28.

According to a variant, the spreader 16 also has a particular configuration. In particular, the spreader 16 is configured so as to be driven in rotation so as to automatically form a pancake on the cooking surface 4a. The axis of rotation is perpendicular to the cooking surface, namely in particular vertical. Preferably, the spreader 16 and its axis, in particular the injection compartment, can be moved between the dispensing point 5 and a position at a distance from the dispensing point 5. In particular, the injection compartment can swivel horizontally and the spreader 16 preferably remains at a height corresponding to a distance of 1 cm above the cooking surface without vertical translations. The spreader can thus “lick” the cooking surface.

The driving in rotation of the spreader 16 is performed through a driving means, which is here a spreading motor 16a as described in more detail below. The spreader 16 is in particular configured to be driven in rotation at a speed of less than 1.5 revolutions per second, more preferably less than 1 revolution per second. These speeds permit to have a quick dispensing of pancake dough and an accelerated rate.

Preferably, the spreader 16 comprises at least one spreading plate 32 provided with a spreading container 33 opening onto a spreading surface 34. Preferably, the spreading container 33 is chiseled in the plate of FIG. 32. The spreading surface 34 may be provided on one side of the plate 32 and the spreader 16 is then configured to be driven in rotation on said side. The spreading container 33 is also a means for calibrating the quantity of dough and uniformize the thicknesses of the cooked pancakes. An open spreading container 33 permits to directly pour the quantity it contains onto the cooking surface 4a. The form of the spreading plate 32 coupled to the spreading container 33 permits to have a regular spreading along a lower edge of the spreading plate 32. The rotational movement permits a spreading around the axis of rotation, thus limiting losses of dough that would occur with a horizontal translation movement of the spreading plate along the cooking surface.

It is possible to consider a spreader 16 with an adjustable spreading container 33, for example with a part that can be made of silicone movable in the spreading container 33 or one or several inserts that can be made of silicone and to be positioned in the spreading container 33.

According to a variant, the spreading container 33 is formed by a longitudinal groove ending onto the spreading surface through at least one, preferably several spreading orifices 35a, 35b, 35c, more preferably of varying sizes. In particular, the spreading orifices 35 are of a size increasing from the axis of rotation of the spreading plate 32 to the end opposite said axis of rotation. In addition, the arrival of dough 36 to the spreading container 33 is substantially close to, in particular at the level of, said axis of rotation. A varying size permits to balance the dispensing of dough under the spreading container 33, because the arrival of dough 36 permits to fill the spreading container up to the next orifice 35b more quickly than the dough passes through the previous orifice 35a. Thus, the spreading container 33 fills centrifugally, then flows centripetally without any other mechanical system for this purpose. Parallelly, the spreader 16 spreads the dough poured onto the cooking surface 4a as it is poured thereon, which provides a significantly improved result, in comparison with the spreading means of the prior art, without using a complex mechanical and electronic system.

Preferably, an arch-shaped structure 37 is provided below at least one, preferably each, orifice 35a-35c. The arch-shaped structures 37 permit to evenly distribute the dough under the container in as many clusters.

In particular, the spreader 16 comprises two spreading plates, among which a second plate 38 is reversibly fastened to the first one 32 so as to form the spreading container 33. Advantageously, this arrangement permits an easier washing by disassembling the two plates 32, 38. A spreading container also chiseled in the second spreading plate 38 can be considered.

Preferably, at least one plate, in particular the second plate 38, comprises asperities 38a on its lower edge. Advantageously, the asperities permit to better distribute the dough on the cooking surface. More preferably, the lower portion near the cooking surface comprises a longitudinal recess 38b overhung by said asperities, which are here spaced apart.

According to a variant, a particular part is provided for making the junction between the injection pump 15 and the driving means, which is here a spreading motor 16a. This is a connection mechanism 39 configured to both convey the dough to the spreading container 33 and drive the spreader 16 in rotation. In particular, a conduit is provided in the mechanism 39, as well as a rotary connection. More particularly, the connection mechanism 39 comprises a plurality of revolving parts encased into each other and associated with at least one seal 40, as well as at least one stop 41 for driving in rotation. The connection mechanism 39 may have a size of less than 5 cm.

The connection mechanism 39 comprises an outer part 42, here a cylindrical part, comprising an inlet mouth 43 connected to the injection circuit 17, and an inner part 44 configured to be accommodated in the outer part 42 while delimiting a space at least partially annular around the inner part 44. The inner part 44 has preferably an axial portion 44a extending along an axis common to the outer 42 and inner 44 parts. The inner part 44 may have a circular rim 45, on which the outer part 42 rests.

An outlet mouth 46 is provided on the connection mechanism for the passing through of the dough to said cooking plate. In particular, the inner part 44 comprises said outlet mouth 46 preferably on its axial portion to a lower portion of the inner part 44. This is a conduit with a diameter of 8 mm. The outlet mouth 46 ends on the arrival of dough 36 of the spreader 16.

The inner part 44 has preferably the shape of dumbbells with circular protrusions 44b on both sides of the axial portion 44a. The upper circular protrusion 44b preferably acts as a support for a driving part 47 connected to a driving means such as said spreading motor 16a. The driving part 47 preferably has a dumbbell shape. The connection between the driving part 47 and the inner part 44 occurs by means of an arm 48 formed for example by a screw passing through the two parts 44, 47, associated with a driving stop here formed by a cleat 49. Preferably, the cleat 49 is formed or fastened, for example screwed, to the inner part 44, and the driving part 47 comprises an accommodation for said cleat. An inverse arrangement or two accommodations can be considered. The inner part 44 is preferably made integral with said spreading plate 32, more preferably through the circular rim 45, for example by means of two screws 50.

1. A cooking system for a cooking machine, the system comprising:
a plurality of cooking devices configured to be successively and cyclically moved to the end of a device for dispensing product to be cooked,
a system for driving the cooking devices, and
a control unit connected to the driving system and to the dispensing device,
wherein the control unit is configured to select part of the cooking devices, onto which the product to be cooked is dispensed.

2. The system according to claim 1, wherein the control unit is configured to select said part of the cooking devices at a regular or almost regular time interval.

3. The system according to claim 1, further comprising a mark identifying the cooking devices and a corresponding mark on an adjustment means of the control unit.

4. The system according to claim 1, wherein said part of the selectable cooking devices corresponds to one cooking device to more than one cooking device.

5. The system according to claim 1, wherein the cooking devices comprise six cooking plates.

6. The system according to claim 1, wherein the control unit is configured to select one adjustment position out of three, corresponding to one plate, three plates, and six plates.

7. The system according to claim 1, further comprising a circular support integral with the cooking devices and a circular handle extending around the circular support.

8. The system according to claim 1, wherein the dispensing device is movable between an activation position, in which it is at the level of a dispensing point, and an inactivation position, in which it is at a distance from the dispensing point, and said positions activate or inactivate the driving system and preferably an automatic product dispensing control.

9. An automaton for preparing pancakes of a control unit of a system according to claim 1, configured to automatically control the system for driving the cooking devices and the dispensing of said product onto the cooking devices, wherein it is adjustable to select part of the cooking devices, on which the product to be cooked is dispensed.

10. A machine for preparing pancakes, comprising a system according to claim 1.

11. The machine according to claim 10, further comprising a system for injecting and spreading cooking dough being comprised of:
a dough container having an outlet,
an injection pump connected to the outlet of the container,
a spreader connected to the injection pump and configured to spread a dough on a circuit cooking surface, and
an injection circuit connecting the container to the spreader.

12. A method for preparing pancakes, the method comprising the steps of:
assembling a system according to claim 1,
varying the number of cooking devices, onto which the pancake dough is dispensed, and
cooking the pancake dough.
